(19) United States
(12) Patent Application Publication
(10) Pub. No.: US 2005/0108160 A1
(43) Pub. Date: May 19, 2005

(54) Line-by-line user interface with multiple links per line item

(75) Inventor: Claire Svetlana Vishik, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/714,823

(22) Filed: Nov. 17, 2003

(51) Int. Cl. G06F 17/60

(52) U.S. Cl. 705/40

(57) ABSTRACT

A line-by-line user interface enables a user to question individual line items in a transaction. The user interface provides multiple links to multiple destinations for multiple question types per line item to facilitate routing a user request to an appropriate destination based on its question type. An extensible Markup Language (XML) representation of each of the individual line items can be processed to automatically create the line-by-line user interface. The XML representation includes tags within which the multiple links per line item are defined.

### BACKGROUND

1. Field of the Disclosure

The present disclosure relates generally to user interfaces for online bills, invoices, and purchase orders.

2. Description of the Related Art

Online billing and procurement applications are employed by many companies to provide billing and/or invoice information. Some applications provide an online bill or an invoice to an end user in the form of a single document with multiple line items. The single document is provided even though information for creating the online bill or invoice frequently comes from a variety of sources and undergoes format translation or transformation along the process.

Questions or disputes may arise based on the end user's review of the online bill. To make his/her concerns known, the end user either contacts a general billing support telephone number or submits a billing question in a message to a generic email address. The question or complaint is received by a person who acts as a dispatcher. The dispatcher forwards the information to one or more relevant business units based on generic instructions. Individuals in the relevant business units may make changes in the bill or invoice based on the information.

The prior process to change unified bills and invoices is expensive in terms of time and effort. Further, errors which occur may take a long time to correct because efforts must be directed to different individuals and departments responsible for execution. As a result, the prior process may lead to multiple errors, delays and lack of customer satisfaction. Paradoxically, a greater ability to achieve integration leads to additional problems rather than providing greater user convenience.

### BRIEF DESCRIPTION OF THE DRAWINGS

The present invention is pointed out with particularity in the appended claims. However, other features are described in the following detailed description in conjunction with the accompanying drawing in which:

FIG. 1 is a block diagram of an embodiment of a system for providing and using a line-by-line user interface;

FIG. 2 illustrates an embodiment of part of an XML representation for a line item;

FIG. 3 illustrates an embodiment of the line-by-line user interface for a line item identifying a telephone call placed by the user; and

FIG. 4 illustrates an embodiment of the line-by-line user interface for a line item in an invoice for which the user is a purchaser.

### DETAILED DESCRIPTION OF THE EMBODIMENTS

Embodiments of the present disclosure provide an interface that allows users of multi-line billing, procurement, or similar applications to single out and question a single line item. This is beneficial since user questions or disputes typically are specific to individual line items rather than a whole document. Each line item or a component thereof represents a unit for which several parameters, such as correct routing and databases to be used for problem resolution, can be defined. Feedback about each item can be quickly and efficiently directed to an appropriate business unit. Further, line items can be automatically corrected if a user's level of access privileges is sufficient and machine-to-machine changes are supported.

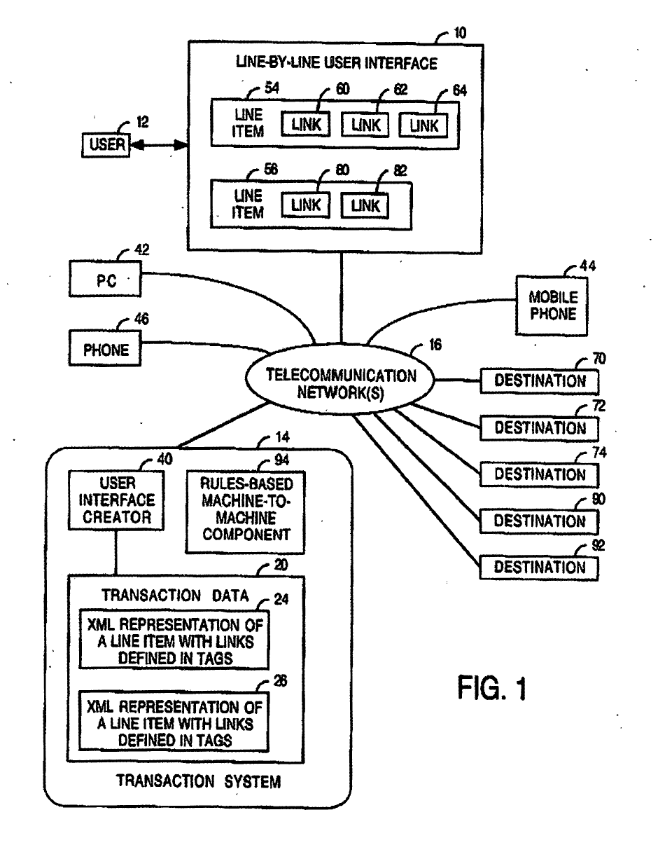

FIG. 1 is a block diagram of an embodiment of a system for providing and using a line-by-line user interface 10. The line-by-line user interface 10 is provided to a user 12 by a network element 14 via one or more telecommunication networks 16. Examples of the telecommunication networks 16 include, but are not limited to, a computer network (e.g. the Internet, an intranet, or an extranet), a digital subscriber line (DSL) network, a cable television broadband access network, a fixed line telephone network, a mobile telephone network, and any combination thereof.

The network element 14 comprises a computer system that provides an online billing system, an online invoice system, an online purchase order system, an online banking system, or another online financial system that either performs, assists, or documents transactions involving the user 12. Without loss of generality, the network element 14 will be referred to as a transaction system for purposes of illustration and example.

The transaction system 14 has computer-readable transaction data 20 stored in a computer-readable medium. The computer-readable transaction data 20 documents a plurality of line items associated with one or more transactions involving the user 12. Typically, the computer-readable medium also includes transaction data documenting line items associated with transactions involving other users.

The computer-readable transaction data 20 represents each line item in a standardized form. For example, a standardized line object can include information about a link to support, a link to payment, and user authentication defined for billing, invoicing and other transaction applications.

In one embodiment, each line item is represented in a markup language such as, eXtensible Markup Language (XML). For purposes of illustration and example, consider two line items in a transaction involving the user 12. In this case, the computer-readable transaction data 20 comprises an XML representation 24 of a first of the two line items, and an XML representation 26 of a second of the two line items. Each XML representation includes tags within which one or more links associated with its line item are defined. The links are to multiple destinations for multiple question types per line item.

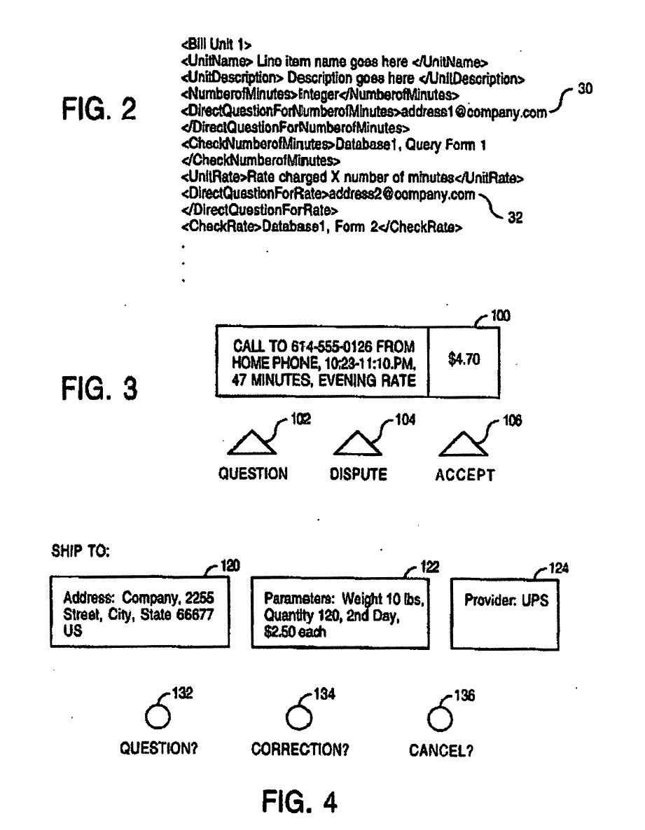

FIG. 2 is an embodiment of part of an XML representation for a line item. In this example, the line item comprises billing information for a telephone call placed by the user 12.

Defined within a UnitName tag is a name of the line item. Defined within a UnitDescription tag is a description of the line item. Defined within a NumberofMinutes tag is a number of minutes associated with a telephone call. Defined within a DirectQuestionForNumberofMinutes tag is a link 30 to a destination to which a question regarding the number of minutes associated with the telephone call is to be directed. Defined within a CheckNumberofMinutes tag is a information identifying a database and/or a form from which the number of minutes data can be queried and verified. Defined within a UnitRate tag is unit rate per minute that the telephone call is charged. Defined within a DirectQuestionForRate tag is a link 32 to a destination to which a question regarding the unit rate associated with the telephone call is to be directed. Defined within a CheckRate tag is a information identifying a database and/or a form from which the unit rate data can be queried and verified. Other tags also may be defined in the XML representation to include other transaction information associated with the line item.

Referring back to FIG. 1, the transaction system 14 comprises a user interface creator 40. Based on the transaction data 20, the user interface creator 40 automatically creates the line-by-line user interface 10 to enable the user 12 to question individual line items in the transaction, and to provide multiple links to multiple destinations for multiple question types per line item to facilitate routing a user request to an appropriate destination based on its question type. In one embodiment, the user interface creator 40 is multi-modal, i.e. it creates different types of user interfaces based on the type of device that presents the line-by-line user interface 10 to the user 12. For example, based on the same transaction data 20, the user interface creator 40 can create a first type of visual user interface for a personal computer system 42, a second type of visual user interface for a mobile telephone 44 having a visual display screen, and an audible user interface for a landline telephone 46.

For Web applications, the line-by-line user interface 10 can be created using languages and formats including, but not limited to, Xforms, Hypertext Markup Language (HTML), XML, JAVA applets, client-side JAVAScript or their successors. For handheld devices, the line-by-line user interface 10 can be created using languages and formats including, but not limited to, Wireless Application Protocol (WAP) and Handheld Device Markup Language (HDML). For audio devices, the line-by-line user interface 10 can be created in a form suitable for presentation by an Interactive Voice Response (IVR) unit.

Regardless of its particular form, the line-by-line user interface 10 presents each line item as a separate unit that is defined at a high level of detail to enable consequent acts associated with the line item, including but not limited to routing, querying a database, checking against rates, questioning, adjusting, disputing or changing. The particular acts that are enabled are dependent on the purpose of the system (e.g. billing, invoicing, purchase orders, or banking).

For purposes of illustration and example, consider the user interface creator 40 processing the XML representation 24 to display information 54 for the first line item, and processing the XML representation 26 to display information 56 for the second line item in the line-by-line user interface 10. For the first line item, the line-by-line user interface 10 includes three user-selectable links 60, 62 and 64, to destinations 70, 72 and 74 respectively, defined in the XML representation 24. For the second line item, the line-by-line user interface 10 includes two user-selectable links 80 and 82, to destinations 90 and 92 respectively, defined in the XML representation 26.

The links 60, 62, 64, 80 and 82 may be to an electronic mail address, an instant messaging (IM) address, an Internet Protocol address, a Uniform Resource Locator (URL), or a telephone number, for example. The links 60, 62, 64, 80 and 82 may facilitate direct communication between the user 12 and a destination via the telecommunication network 16, or may facilitate communication between the user 12 and the destination where the transaction system 14 acts as an intermediary. An example of direct communication occurs if any of the links 60, 62, 64, 80 or 82 comprises a hyperlink to its corresponding one of the destinations 70, 72, 74, 90 and 92. An example of the intermediary is a rules-based machine-to-machine communication component 94. The component 94 employs an ontology to support querying, routing, and rules-based activities. In general, some of the links 60, 62, 64, 80 and 82 may facilitate communication with humans to address some types of questions, while others of the links may facilitate machine-to-machine communication to address other types of questions without requiring human intervention.

FIG. 3 discloses an embodiment of the line-by-line user interface 10 for a line item comprising a telephone call placed by the user 12. The user interface comprises a display of line item information 100 indicating that the telephone call: was placed to a particular telephone number (e.g. 614-555-0126) from a particular telephone line (e.g. home phone); took place between a particular start time (e.g. 10:23 PM) and a particular end time (e.g. 11:10 PM) resulting in a billed number of minutes (e.g. 47 minutes); was billed at a particular rate (e.g. an evening rate); and has a particular charge (e.g. $4.70) associated therewith. It is noted that each of the above properties of the telephone call can be separable objects in alternative embodiments of the interface.

The user interface further comprises a user-selectable control 102 to question the line item, a user-selectable control 104 to dispute the line item, and a user-selectable control 106 to accept the line item. In response to a user selection of the control 102, an online form may be provided to the user 12 within which he/she can textually enter a question associated with the line item. The rules-based machine-to-machine component 94 can process the question to automatically generate a first database query if the question pertains to the number of minutes, or a second database query if the question pertains to the rate that was charged. The database query is used to check for an error in the transaction data without requiring human intervention. Alternatively, the question may be routed to one electronic mail address (e.g. address1@company.com) if the question pertains to the number of minutes, or many be routed to a different electronic mail address (e.g. address2@company.com) if the question pertains to the rate that was charged. In this case, either a human or an automated system at the electronic address can process the question to check for an error in the particular transaction data.

The user 12 can dispute a particular part of the line item in response to a user selection of the control 104. The dispute may be routed to one electronic mail address (e.g. address1@company.com) if the dispute pertains to the number of minutes, or many be routed to a different electronic mail address (e.g. address2@company.com) if the dispute pertains to the rate that was charged. Either a human or an automated system at the electronic address can handle the dispute.

In response to a user selection of the control 106, a next line item (if it exists) is presented to the user 12.

FIG. 4 illustrates an embodiment of the line-by-line user interface 10 for a line item in an invoice for which the user 12 is a purchaser. The user interface comprises a display of address information 120, transaction parameter information 122 and shipping provider information 124. The address information 120 includes a company name, a street address, a city, a state, a postal code and a country identifying the purchaser. The transaction parameter information 122 includes a weight, a quantity, a unit cost and a shipping priority associated with a purchase. The shipping provider information 124 identifies a shipping provider associated with the purchase.

The user interface further comprises a user-selectable button 132 to question the line item, a user-selectable button 134 to correct the line item, and a user-selectable button 136 to cancel the line item. The button 132 provides a link to a shipping help desk. The button 134 provides a link to a system administrator having the authority to change the line item information. The button 136 provides a link to an account administrator.

For purposes of illustration and example, consider the user 12 noticing an error in the line item. The user 12 clicks on or otherwise selects the button 134 to correct the error. In response to the user selection of the button 134, an online form having the line item information pops up to the user 12. Using the online form, the user 12 textually edits the error in the line item information. For example, the user 12 may replace “$2.50 each” with “$2.30 each per contract” in the transaction parameter information 122. The correction is sent to the system administrator with the authority to change the record or, if desirable and supported, directly to the system.

Three more examples illustrating embodiments and applications of the line-by-line user interface are as follows.

### EXAMPLE 1

### A Question about a Phone Bill

Consider a user who receives a bill that itemizes multiple telephony services, such as a fixed wireline telephone service, a wireless telephone service, and a dial-up Internet access service. The user notices on the bill that he/she has been overcharged for the dial-up Internet access. The user accesses the bill online, and double-clicks or otherwise selects a line item associated with the dial-up Internet access. In response to the user selection of the line item, an online form is presented to the user. Into the online form, the user enters a message describing his/her concern with the line item. For example, the user may type or write “I have been charged twice for the account set-up”, and click or otherwise select a submit button associated with the online form. The message is delivered to the dial-up provider, automatically matched to the user's account, and the duplication is deleted. No further intervention is required.

### EXAMPLE 2

### A Problem with a Mortgage Statement

Consider a user who listens to his/her mortgage payment statement on a telephone. The mortgage payment statement is audibly provided as a series of line items or components thereof. Each line item or component is followed by a pause period to allow the user to issue a command. The command may be either verbal or manual such as pressing numbers on his/her telephone. If no command is received within a pause period, a subsequent line item or component is audibly provided to the user.

For example, consider the following exchange between an embodiment of the system and the user. The system presents a first audible message such as “Your mortgage payment was received on Jun. 13, 2002”. After a 20-second pause period in which the user issues no command, the system presents a second audible message such as “Your interest payment was $1673.53”. After another 20-second pause period in which the user issues no command, the system presents a third audible message such as “Your principal payment was $503.22”. After yet another 20-second pause period in which the user issues no command, the system presents a fourth audible message such as “Your escrow payment was $200”. Disagreeing with this line item, the user says “Question” during a pause period. In response thereto, the system presents an audible message such as “Please submit a question on your escrow payment”. The user responds by saying “This charge was additional principal and not escrow. Done. Continue”. The question is recorded and forwarded to a specific department responsible for handling escrow payments. The system continues by sequentially presenting to the user any subsequent line items and a total payment.

### EXAMPLE 3

### Approving a Purchase Order

Consider a user accessing a purchase order from a cellular telephone at an airport. The purchase order was submitted for approval by the user. Each line item in the purchase order is audibly presented to the user. The user is allowed to provide feedback based on each line item. The feedback may pertain to a quantity, a part number, or a price, for example.

Consider that a contracted discount rate does not come through on one of the line items. In response thereto, the user presses a key on his/her telephone and speaks a comment such as “Please adjust to the contracted rate”. The user then issues a command, either vocally or manually, that approves the purchase order with the exception of the line in question.

The herein-described methods and systems allow users to review many types of business and consumer documents that have a spreadsheet-like format in a line-by-line manner amenable for visual applications that may have small display screens like cellular telephones and personal digital assistants (PDAs), and speech applications such as reviewing a bill over a telephone. Devising a system and data format that allows multi-modal access to a business document is easier when the smallest object is a line item of the business document.

Since multiple links are defined for at least one, and potentially all, of the line items, users can provide immediate feedback (e.g. questions or concerns) that is routed in a highly-focused manner to a specific department. In a speech application, for example, a user can review a telephone bill when he/she is away from home, can drill down a list of line items, and can provide feedback for those line items that require action.

Organizations issuing bills, purchase orders, and other online transaction information can improve their customer support and cut expenses by eliminating dispatchers whose only purpose is to collect and redirect queries. Further, problem resolution is more efficient when only the line item that requires intervention is discussed rather than the whole business document. Embodiments of the herein-disclosed user interface may be integrated with workflow or business process management tools to enable its maintainers to edit, amend and extend the process of routing requests seamlessly for end users.

Those having ordinary skill will recognize that the herein-disclosed computer-implemented acts can be directed by computer-readable program code stored by a computer-readable medium. Examples of the computer-readable medium include, but are not limited to, a magnetic medium such as a hard disk or a floppy disk, an optical medium such as an optical disk (e.g. a CD or a DVD), or an electronic medium such as an electronic memory (e.g. a computer's internal memory or a removable memory such as a memory card). The herein-disclosed databases and files can be embodied by computer-readable media having computer-readable data stored thereon.

It will be apparent to those skilled in the art that the disclosed embodiments may be modified in numerous ways and may assume many forms other than the forms specifically set out and described herein.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method comprising:
providing a line-by-line user interface to enable a user to question individual line items in a transaction, wherein the user interface provides multiple links to multiple destinations for multiple question types per line item to facilitate routing a user request to an appropriate destination based on its question type.

2. The method of claim 1 further comprising:
processing an extensible Markup Language (XML) representation of each of the individual line items to create the line-by-line user interface, wherein the XML representation includes tags within which the multiple links per line item are defined.

3. The method of claim 1 wherein the XML representation identifies a database from which data associated with a line item can be verified.

4. The method of claim 1 wherein for a line item, the multiple links comprise a first link to question the line item and a second link to dispute the line item.

5. The method of claim 1 wherein for a line item, the multiple links comprise a first link to question the line item and a second link to correct the line item.

6. The method of claim 1 wherein for a line item, the multiple links comprise a first link to question an amount of a product or a service associated with the line item and a second link to question a billing rate associated with the line item.

7. The method of claim 6 wherein the amount comprises an amount of time.

8. The method of claim 1 wherein the multiple links comprise a plurality of electronic mail addresses.

9. The method of claim 1 further comprising:
for a line item, providing an online form to receive user-entered text to direct to a user-selected one of the multiple links.

10. The method of claim 1 wherein the multiple links comprise a first link that facilitates communication with a human to address a first question type, and a second link that facilitates machine-to-machine communication to address a second question type without requiring human intervention.

11. The method of claim 1 wherein the user interface is integrated with a workflow or business process management tool to enable a maintainer to edit, amend and extend a process of routing user requests.

12. A system comprising:
a computer system to provide a line-by-line user interface to enable a user to question individual line items in a transaction, wherein the user interface provides multiple links to multiple destinations for multiple question types per line item to facilitate routing a user request to an appropriate destination based on its question type.

13. The system of claim 12 wherein the computer system comprises a user interface creator to process an eXtensible Markup Language (XML) representation of each of the individual line items to create the line-by-line user interface, wherein the XML representation includes tags within which the multiple links per line item are defined.

14. The system of claim 12 wherein the XML representation identifies a database from which data associated with a line item can be verified.

15. The system of claim 12 wherein for a line item, the multiple links comprise a first link to question the line item and a second link to dispute the line item.

16. The system of claim 12 wherein for a line item, the multiple links comprise a first link to question the line item and a second link to correct the line item.

17. The system of claim 12 wherein for a line item, the multiple links comprise a first link to question an amount of a product or a service associated with the line item and a second link to question a billing rate associated with the line item.

18. The system of claim 17 wherein the amount comprises an amount of time.

19. The system of claim 12 wherein the multiple links comprise a plurality of electronic mail addresses.

20. The system of claim 12 wherein the computer system is to provide, for a line item, an online form to receive user-entered text to direct to a user-selected one of the multiple links.

21. The system of claim 12 wherein the multiple links comprise a first link that facilitates communication with a human to address a first question type, and a second link that facilitates machine-to-machine communication to address a second question type without requiring human intervention.

22. The system of claim 12 wherein the user interface is integrated with a workflow or business process management tool to enable a maintainer to edit, amend and extend a process of routing user requests.

23. A computer-readable medium having computer-readable program code to direct a computer system to provide a line-by-line user interface to enable a user to question individual line items in a transaction, wherein the user interface provides multiple links to multiple destinations for multiple question types per line item to facilitate routing a user request to an appropriate destination based on its question type.

24. The computer-readable medium of claim 23 wherein the computer-readable program code directs the computer system to process an extensible Markup Language (XML) representation of each of the individual line items to create the line-by-line user interface, wherein the XML representation includes tags within which the multiple links per line item are defined.

25. The computer-readable medium of claim 23 wherein the XML representation identifies a database from which data associated with a line item can be verified.

26. The computer-readable medium of claim 23 wherein for a line item, the multiple links comprise a first link to question the line item and a second link to dispute the line item.

27. The computer-readable medium of claim 23 wherein for a line item, the multiple links comprise a first link to question the line item and a second link to correct the line item.

28. The computer-readable medium of claim 23 wherein for a line item, the multiple links comprise a first link to question an amount of a product or a service associated with the line item and a second link to question a billing rate associated with the line item.

29. The computer-readable medium of claim 28 wherein the amount comprises an amount of time.

30. The computer-readable medium of claim 23 wherein the multiple links comprise a plurality of electronic mail addresses.

31. The computer-readable medium of claim 23 wherein the computer-readable program code is to direct the computer system to provide, for a line item, an online form to receive user-entered text to direct to a user-selected one of the multiple links.

32. The computer-readable medium of claim 23 wherein the multiple links comprise a first link that facilitates communication with a human to address a first question type, and a second link that facilitates machine-to-machine communication to address a second question type without requiring human intervention.

33. The computer-readable medium of claim 23 wherein the user interface is integrated with a workflow or business process management tool to enable a maintainer to edit, amend and extend a process of routing user requests.
